(19) United States
(12) Patent Application Publication
(10) Pub. No.: US 2026/0005809 A1
(43) Pub. Date: Jan. 1, 2026

(54) PATTERNS OF VIRTUAL PILOTS FOR 6G PHYSICAL SHARED CHANNELS

(71) Applicant: QUALCOMM Incorporated, San Diego, CA (US)

(72) Inventors: Chih-Hao LIU, San Diego, CA (US); Eric Paul SOLLENBERGER, Broomfield, CO (US); Jing SUN, San Diego, CA (US); Somsubhra BARIK, San Diego, CA (US)

(21) Appl. No.: 18/759,259

(22) Filed: Jun. 28, 2024

(51) Int. Cl. H04L 5/00; H04W 72/23

(52) U.S. Cl. CPC H04L 5/0048; H04L 5/0007; H04W 72/23

(57) ABSTRACT

Various aspects of the present disclosure generally relate to wireless communication. In some aspects, a wireless communication device may receive, via a first port, a first layer of a multi-layer communication, wherein data carrying first virtual pilots associated with the first layer is carried in a first set of data tones associated with a first comb offset of a frequency-domain comb structure. The wireless communication device may receive, via a second port, a second layer of the multi-layer communication, wherein data carrying second virtual pilots associated with the second layer is carried in a second set of data tones associated with a second comb offset of the frequency-domain comb structure. Numerous other aspects are described.

### FIELD OF THE DISCLOSURE

Aspects of the present disclosure generally relate to wireless communication and specifically relate to techniques, apparatuses, and methods for patterns of virtual pilots for 6G physical sidelink channels.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a wireless communication device. The method may include receiving, via a first port, a first layer of a multi-layer communication, wherein data carrying first virtual pilots associated with the first layer is carried in a first set of data tones associated with a first comb offset of a frequency-domain comb structure. The method may include receiving, via a second port, a second layer of the multi-layer communication, wherein data carrying second virtual pilots associated with the second layer is carried in a second set of data tones associated with a second comb offset of the frequency-domain comb structure.

Some aspects described herein relate to a method of wireless communication performed by a wireless communication device. The method may include transmitting, via a first port, a first layer of a multi-layer communication, wherein data carrying first virtual pilots associated with the first layer is carried in a first set of data tones associated with a first comb offset of a frequency-domain comb structure. The method may include transmitting, via a second port, a second layer of the multi-layer communication, wherein data carrying second virtual pilots associated with the second layer is carried in a second set of data tones associated with a second comb offset of the frequency-domain comb structure.

Some aspects described herein relate to a wireless communication device for wireless communication. The wireless communication device may include one or more memories and one or more processors coupled to the one or more memories. The one or more processors may be configured to receive, via a first port, a first layer of a multi-layer communication, wherein data carrying first virtual pilots associated with the first layer is carried in a first set of data tones associated with a first comb offset of a frequency-domain comb structure. The one or more processors may be configured to receive, via a second port, a second layer of the multi-layer communication, wherein data carrying second virtual pilots associated with the second layer is carried in a second set of data tones associated with a second comb offset of the frequency-domain comb structure.

Some aspects described herein relate to a wireless communication device for wireless communication. The wireless communication device may include one or more memories and one or more processors coupled to the one or more memories. The one or more processors may be configured to transmit, via a first port, a first layer of a multi-layer communication, wherein data carrying first virtual pilots associated with the first layer is carried in a first set of data tones associated with a first comb offset of a frequency-domain comb structure. The one or more processors may be configured to transmit, via a second port, a second layer of the multi-layer communication, wherein data carrying second virtual pilots associated with the second layer is carried in a second set of data tones associated with a second comb offset of the frequency-domain comb structure.

Some aspects described herein relate to a non-transitory computer-readable medium that stores a set of instructions for wireless communication by a wireless communication device. The set of instructions, when executed by one or more processors of the wireless communication device, may cause the wireless communication device to receive, via a first port, a first layer of a multi-layer communication, wherein data carrying first virtual pilots associated with the first layer is carried in a first set of data tones associated with a first comb offset of a frequency-domain comb structure. The set of instructions, when executed by one or more processors of the wireless communication device, may cause the wireless communication device to receive, via a second port, a second layer of the multi-layer communication, wherein data carrying second virtual pilots associated with the second layer is carried in a second set of data tones associated with a second comb offset of the frequency-domain comb structure.

Some aspects described herein relate to a non-transitory computer-readable medium that stores a set of instructions for wireless communication by a wireless communication device. The set of instructions, when executed by one or more processors of the wireless communication device, may cause the wireless communication device to transmit, via a first port, a first layer of a multi-layer communication, wherein data carrying first virtual pilots associated with the first layer is carried in a first set of data tones associated with a first comb offset of a frequency-domain comb structure. The set of instructions, when executed by one or more processors of the wireless communication device, may cause the wireless communication device to transmit, via a second port, a second layer of the multi-layer communication, wherein data carrying second virtual pilots associated with the second layer is carried in a second set of data tones associated with a second comb offset of the frequency-domain comb structure.

Some aspects described herein relate to an apparatus for wireless communication. The apparatus may include means for receiving, via a first port, a first layer of a multi-layer communication, wherein data carrying first virtual pilots associated with the first layer is carried in a first set of data tones associated with a first comb offset of a frequency-domain comb structure. The apparatus may include means for receiving, via a second port, a second layer of the multi-layer communication, wherein data carrying second virtual pilots associated with the second layer is carried in a second set of data tones associated with a second comb offset of the frequency-domain comb structure.

Some aspects described herein relate to an apparatus for wireless communication. The apparatus may include means for transmitting, via a first port, a first layer of a multi-layer communication, wherein data carrying first virtual pilots associated with the first layer is carried in a first set of data tones associated with a first comb offset of a frequency-domain comb structure. The apparatus may include means for transmitting, via a second port, a second layer of the multi-layer communication, wherein data carrying second virtual pilots associated with the second layer is carried in a second set of data tones associated with a second comb offset of the frequency-domain comb structure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of a slot format, in accordance with the present disclosure.

FIG. 5 is a diagram illustrating an example associated with a frame structure in a wireless communication network, in accordance with the present disclosure.

FIG. 6 is a diagram illustrating an example of physical channels and reference signals in a wireless network, in accordance with the present disclosure.

FIGS. 7-11 are diagrams illustrating examples associated with communicating virtual pilots for 6G physical shared channels, in accordance with the present disclosure.

FIGS. 12-13 are flowcharts illustrating example processes performed, for example, by a wireless communication device, in accordance with the present disclosure.

FIG. 14-15 are diagrams of example apparatuses for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Data aided channel estimation may be used to reduce demodulation reference signal (DMRS) overhead (e.g., reduce a number of transmissions of DMRSs) and improve channel estimation quality for time varying channels (e.g., Doppler channels). As an example, a slot may carry a DMRS symbol. A wireless communication device may receive the slot, perform channel estimation based at least in part on the DMRS, and attempt to reconstruct data tones in a quadrature amplitude modulation (QAM) symbol (e.g., a virtual pilot symbol) as virtual pilot tones. To perform channel estimation on the virtual pilot tones, the wireless communication device may multiply the reconstructed virtual pilot tones with frequency-domain received signals to calculate the channel estimates. However, to compute the virtual pilot tones is computationally expensive because it requires a matrix inversion for each virtual pilot tone. Further, the matrix inversion is different for each virtual pilot tones, thereby increasing the computational complexity.

Various aspects relate generally to orthogonal virtual pilot configurations. Some aspects more specifically relate to a least-squares (LS) method for computing a virtual pilot (e.g., a set of virtual pilot tones and/or a set of virtual pilot symbols) that avoids having to calculate a rank X rank matrix inversion for each virtual pilot tone. In some aspects, for a two layer communication, a QAM constellation is constructed that ensures that QAM symbol vectors from each layer are orthogonal. In some aspects, different DMRSs associated with different ports are mapped to different comb indexes in frequency tones. Mapping the different DMRSs to the different comb indexes in frequency tones may cause the received frequency-domain (FD) in-phase and quadrature (IQ) (FDIQ) samples from one layer to be orthogonal to the FDIQ samples from another layer in the FD.

Particular aspects of the subject matter described in this disclosure can be implemented to realize one or more of the following potential advantages. In some examples, by ensuring that QAM symbol vectors from each layer of a multi-layer communication are orthogonal, the described techniques can be used to reconstruct a virtual pilot tone using simple multiplication (e.g., without having to calculate a rank X rank matrix inversion for each virtual pilot tone). By reconstructing virtual pilot tones using simple multiplication, a computational complexity of performing channel estimation may be reduced.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

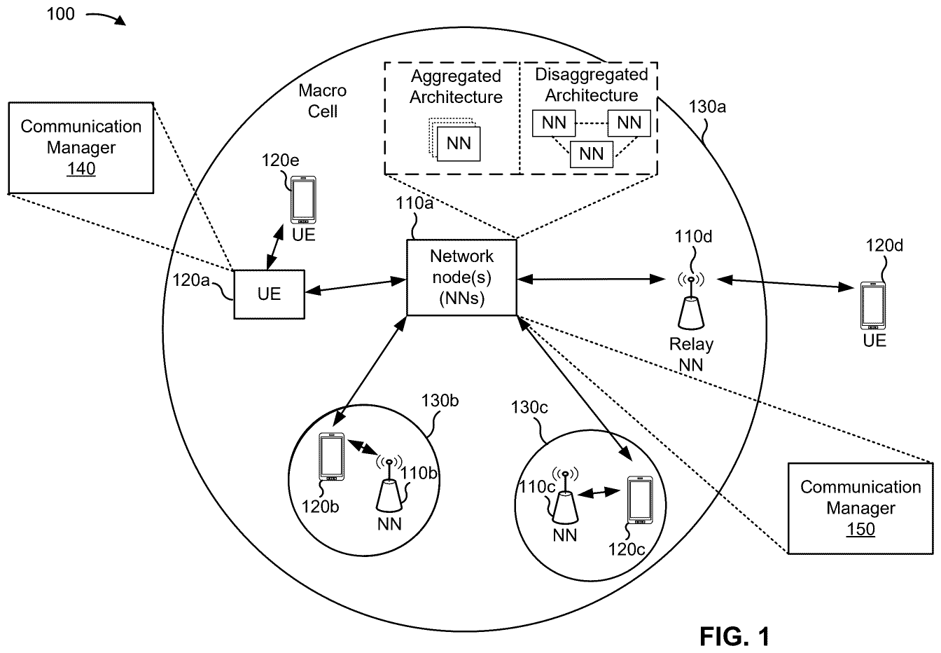

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a wireless communication may include a communication manager 140 and/or a communication manager 150. As described in more detail elsewhere herein, the communication manager 140 and/or the communication manager 150 may receive, via a first port, a first layer of a multi-layer communication, wherein data carrying first virtual pilots associated with the first layer is carried in a first set of data tones associated with a first comb offset of a frequency-domain comb structure; and may receive, via a second port, a second layer of the multi-layer communication, wherein data carrying second virtual pilots associated with the second layer is carried in a second set of data tones associated with a second comb offset of the frequency-domain comb structure. Additionally or alternatively, the communication manager 140 may perform one or more other operations described herein.

In some aspects, a wireless communication may include a communication manager 140 and/or a communication manager 150. As described in more detail elsewhere herein, the communication manager 140 and/or the communication manager 150 may transmit, via a first port, a first layer of a multi-layer communication, wherein data carrying first virtual pilots associated with the first layer is carried in a first set of data tones associated with a first comb offset of a frequency-domain comb structure; and may transmit, via a second port, a second layer of the multi-layer communication, wherein data carrying second virtual pilots associated with the second layer is carried in a second set of data tones associated with a second comb offset of the frequency-domain comb structure. Additionally or alternatively, the communication manager 140 may perform one or more other operations described herein.

As indicated above, FIG. 1 is provided as an example. Other examples may differ from what is described with regard to FIG. 1.

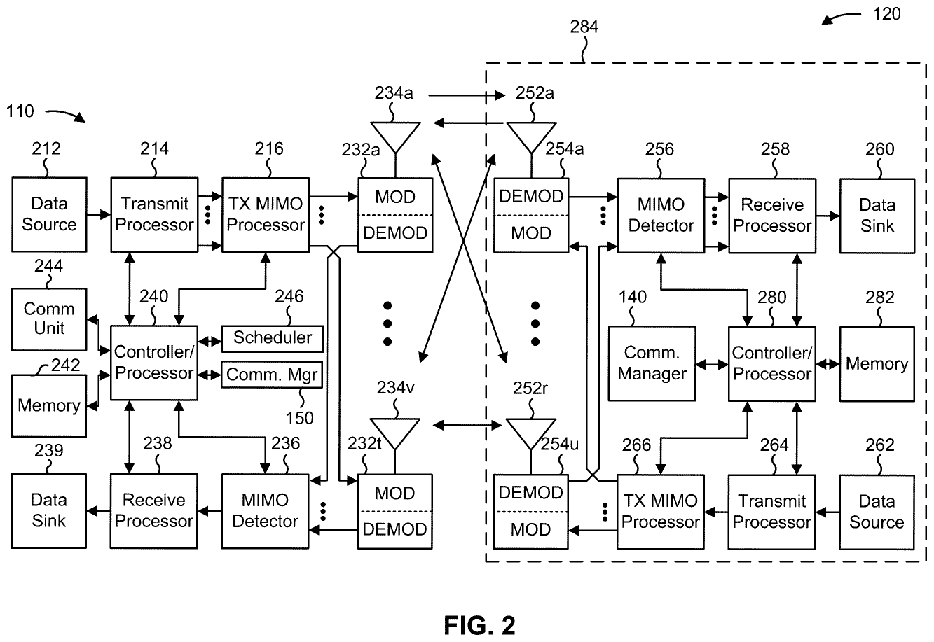

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

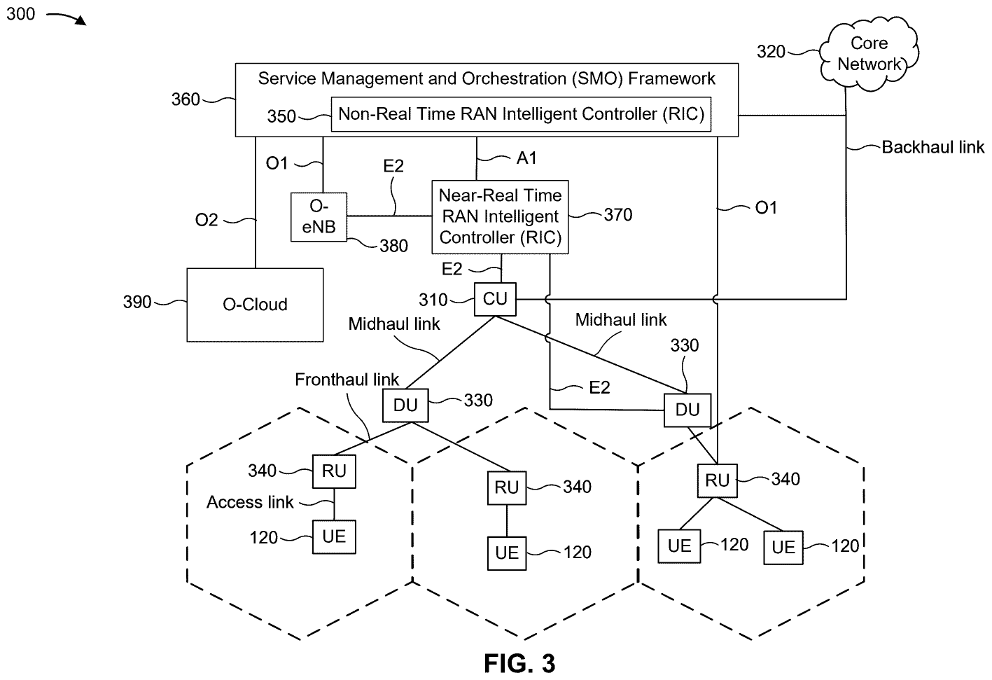

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

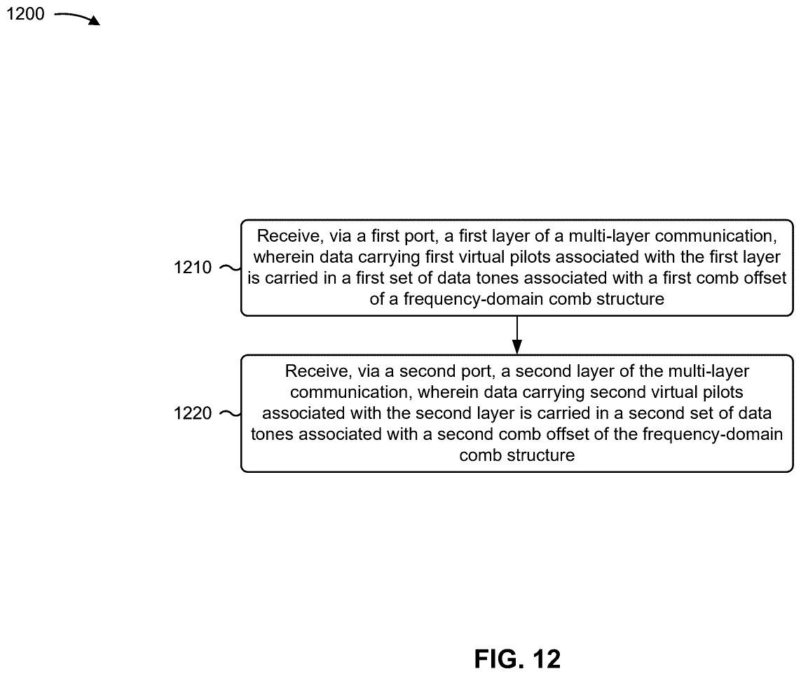

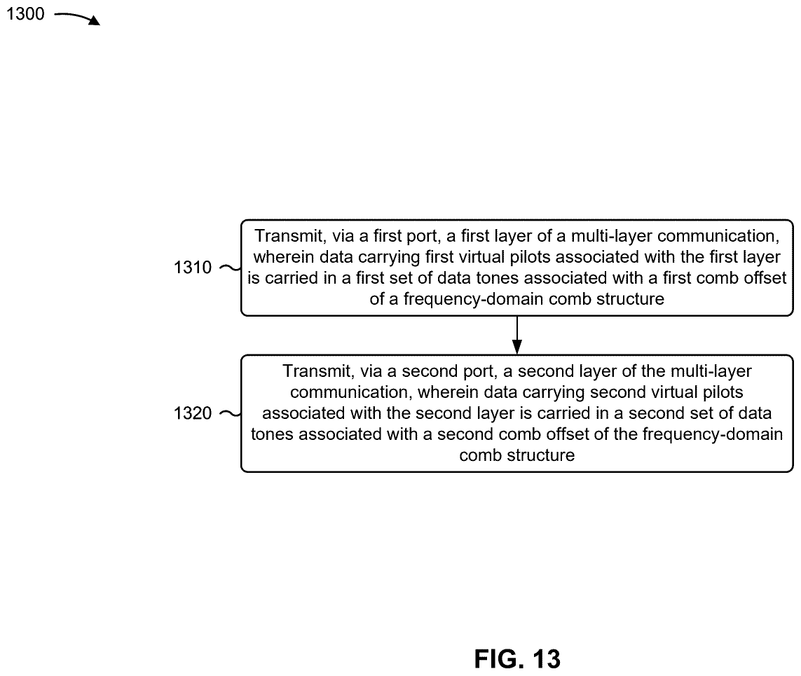

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with patterns of virtual pilots for 6G physical shared channels (PxSCHs), such as a PUSCH and/or a PDSCH, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1200 of FIG. 12, process 1300 of FIG. 13, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

In some aspects, a wireless communication device (e.g., a network node 110, a UE 120) may include means for receiving, via a first port, a first layer of a multi-layer communication, wherein data carrying first virtual pilots associated with the first layer is carried in a first set of data tones associated with a first comb offset of a frequency-domain comb structure, means for receiving, via a first port, a first layer of a multi-layer communication, wherein data carrying first virtual pilots associated with the first layer is carried in a first set of data tones associated with a first comb offset of a frequency-domain comb structure, or the like. In some aspects, such means may include one or more components of network 110 described in connection with FIG. 2, such as antenna 234, MIMO detector 236, receive processor 238, controller/processor 240, transmit processor 214, TX MIMO processor 216, modem 232, antenna 234, or the like. In some aspects, such means may include one or more components of UE 120 described in connection with FIG. 2, such as controller/processor 280, transmit processor 264, TX MIMO processor 266, antenna 252, modem 254, MIMO detector 256, receive processor 258, or the like.

In some aspects, a wireless communication device (e.g., a network node 110, a UE 120) may include means for transmitting, via a first port, a first layer of a multi-layer communication, wherein data carrying first virtual pilots associated with the first layer is carried in a first set of data tones associated with a first comb offset of a frequency-domain comb structure, means for transmitting, via a first port, a first layer of a multi-layer communication, wherein data carrying first virtual pilots associated with the first layer is carried in a first set of data tones associated with a first comb offset of a frequency-domain comb structure, or the like. In some aspects, such means may include one or more components of network 110 described in connection with FIG. 2, such as antenna 234, MIMO detector 236, receive processor 238, controller/processor 240, transmit processor 214, TX MIMO processor 216, modem 232, antenna 234, or the like. In some aspects, such means may include one or more components of UE 120 described in connection with FIG. 2, such as controller/processor 280, transmit processor 264, TX MIMO processor 266, antenna 252, modem 254, MIMO detector 256, receive processor 258, or the like.

As indicated above, FIG. 3 is provided as an example. Other examples may differ from what is described with regard to FIG. 3.

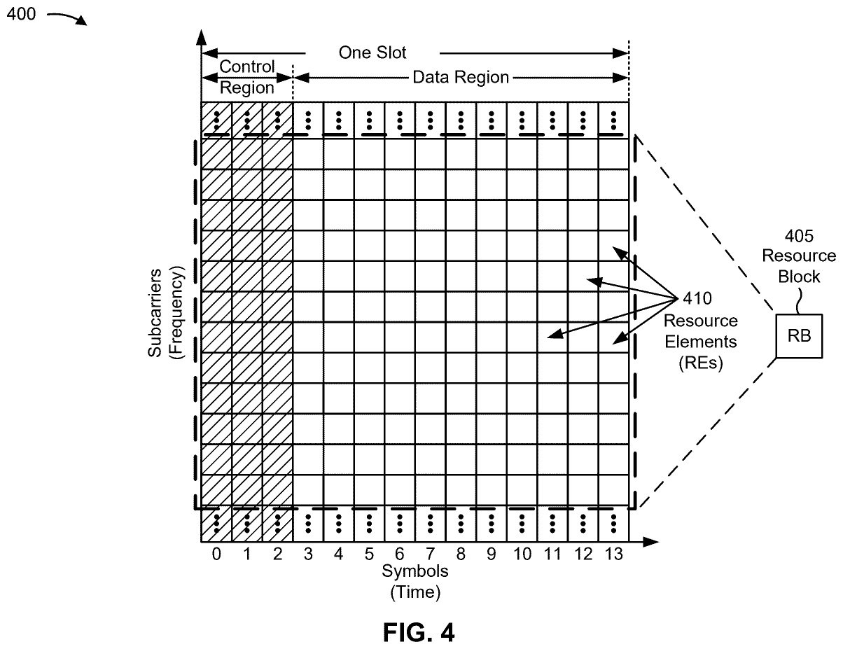

FIG. 4 is a diagram illustrating an example 400 of a slot format, in accordance with the present disclosure. As shown in FIG. 4, time-frequency resources in a radio access network may be partitioned into resource blocks, shown by a single resource block (RB) 405. An RB 405 is sometimes referred to as a physical resource block (PRB). An RB 405 includes a set of subcarriers (e.g., 12 subcarriers) and a set of symbols (e.g., 14 symbols) that are schedulable by a network node 110 as a unit. In some aspects, an RB 405 may include a set of subcarriers in a single slot. As shown, a single time-frequency resource included in an RB 405 may be referred to as a resource element (RE) 410. An RE 410 may include a single subcarrier (e.g., in frequency) and a single symbol (e.g., in time). A symbol may be referred to as an OFDM symbol. An RE 410 may be used to transmit one modulated symbol, which may be a real value or a complex value.

In some telecommunication systems (e.g., NR), RBs 405 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 4 is provided as an example. Other examples may differ from what is described with respect to FIG. 4.

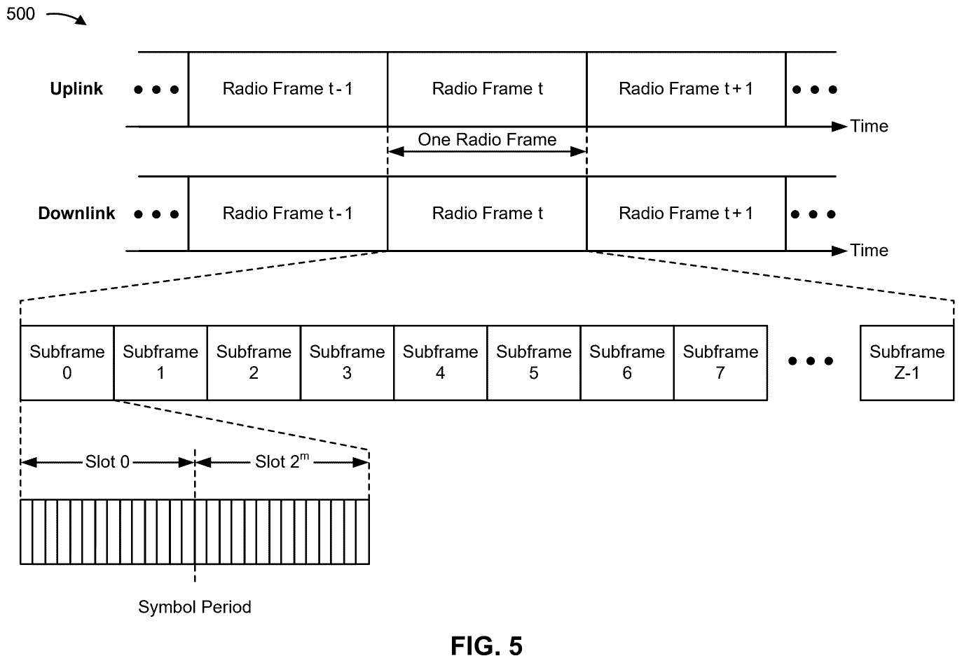

FIG. 5 is a diagram illustrating an example 500 of a frame structure in a wireless communication network, in accordance with the present disclosure. The frame structure shown in FIG. 5 is for frequency division duplexing (FDD) in a telecommunication system, such as LTE or NR. The transmission timeline for each of the downlink and uplink may be partitioned into units of radio frames (sometimes referred to as frames). Each radio frame may have a predetermined duration (e.g., 10 ms) and may be partitioned into a set of Z (Z≥1) subframes (e.g., with indices of 0 through Z−1). Each subframe may have a predetermined duration (e.g., 1 ms) and may include a set of slots (e.g., 2^{m} slots per subframe are shown in FIG. 5, where m is an index of a numerology used for a transmission, such as 0, 1, 2, 3, 4, or another number). Each slot may include a set of L symbol periods. For example, each slot may include fourteen symbol periods (e.g., as shown in FIG. 5), seven symbol periods, or another number of symbol periods. In a case where the subframe includes two slots (e.g., when m=1), the subframe may include 2L symbol periods, where the 2L symbol periods in each subframe may be assigned indices of 0 through 2L−1. In some aspects, a scheduling unit for the FDD may be frame-based, subframe-based, slot-based, mini-slot based, or symbol-based.

As indicated above, FIG. 5 is provided as an example. Other examples may differ from what is described with respect to FIG. 5.

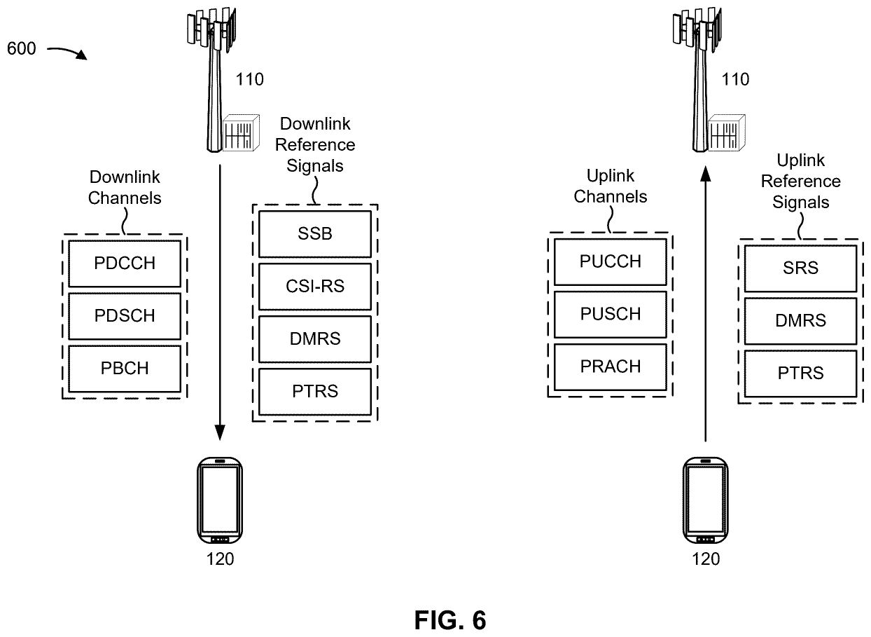

FIG. 6 is a diagram illustrating an example 600 of physical channels and reference signals in a wireless network, in accordance with the present disclosure. As shown in FIG. 6, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a CSI reference signal (CSI-RS), a DMRS, a PRS, or a PTRS, among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

Pilot aided channel estimation may be used to obtain accurate channel state information (CSI) at a receiver (e.g., at a wireless communication device (e.g., a network node 110 and/or a UE 120) receiving a communication). In general, pilot aided channel estimation includes receiving a communication that includes pilot signals at known locations and estimating the CSI from received signals observed during transmission of the communication.

In some cases, the CSI may be estimated by using a least squares estimation that minimizes a sum of squared errors in the estimated CSI at the receiver. The accuracy of the CSI at the receiver obtained from pilot aided channel estimation may improve with an increase in the number of the pilot signals. In addition, an increase in the number of spatially multiplexed data streams utilized to transmit the communication may result in an increase in the number of pilot signals required to accurately estimate the CSI at the receiver. However, increasing the number of pilot signals may reduce an amount of resources available for transmitting data (e.g., non-pilot) signals.

Data aided channel estimation may be used to overcome the limitation of pilot aided channel estimation due to an insufficient number of pilot signals. In general, data aided channel estimation uses data symbols as additional pilot signals to update an initial channel estimate obtained from pilot aided channel estimation.

As an example, a slot may carry a DMRS symbol. A wireless communication device may receive the slot, perform channel estimation based at least in part on the DMRS, and attempt to reconstruct data tones in a QAM symbol (e.g., a virtual pilot symbol) as virtual pilot tones. To perform channel estimation on the virtual pilot symbol, the wireless communication device may multiply the reconstructed virtual pilot tones with frequency-domain received signals to calculate the channel estimates. However, to compute each virtual pilot tone, the wireless communication device may compute rank X rank matrix inversion, which is computationally expensive. Further, the rank X rank matrix is different for different virtual pilot tones, thereby increasing the computational complexity.

Some aspects described herein relate to orthogonal virtual pilot configurations. As used herein, “orthogonal” refers to two or more transmissions that have no influence on each other when transmitted via overlapping resources (e.g., a transmission of one signal does not interfere with a transmission of another signal). Some aspects more specifically relate to a least-squares (LS) method for computing virtual pilot tones that avoids having to calculate a rank X rank matrix inversion for each virtual pilot tone. In some aspects, for a two layer communication, a QAM constellation is constructed that ensures that QAM symbol vectors from each layer are orthogonal. In some aspects, different DMRSs associated with different ports are mapped to different comb indexes in frequency tones. Mapping the different DMRSs to the different comb indexes in frequency tones may cause the received FDIQ samples from one layer to be orthogonal to the FDIQ samples from another layer in the FD.

By ensuring that QAM symbol vectors from each layer of a multi-layer communication are orthogonal, the described techniques can be used to reconstruct a virtual pilot tone using simple multiplication (e.g., without having to calculate a rank X rank matrix inversion for each virtual pilot tone). By reconstructing virtual pilot tones using simple multiplication, a computational complexity of performing channel estimation may be reduced.

As indicated above, FIG. 6 is provided as an example. Other examples may differ from what is described with regard to FIG. 6.

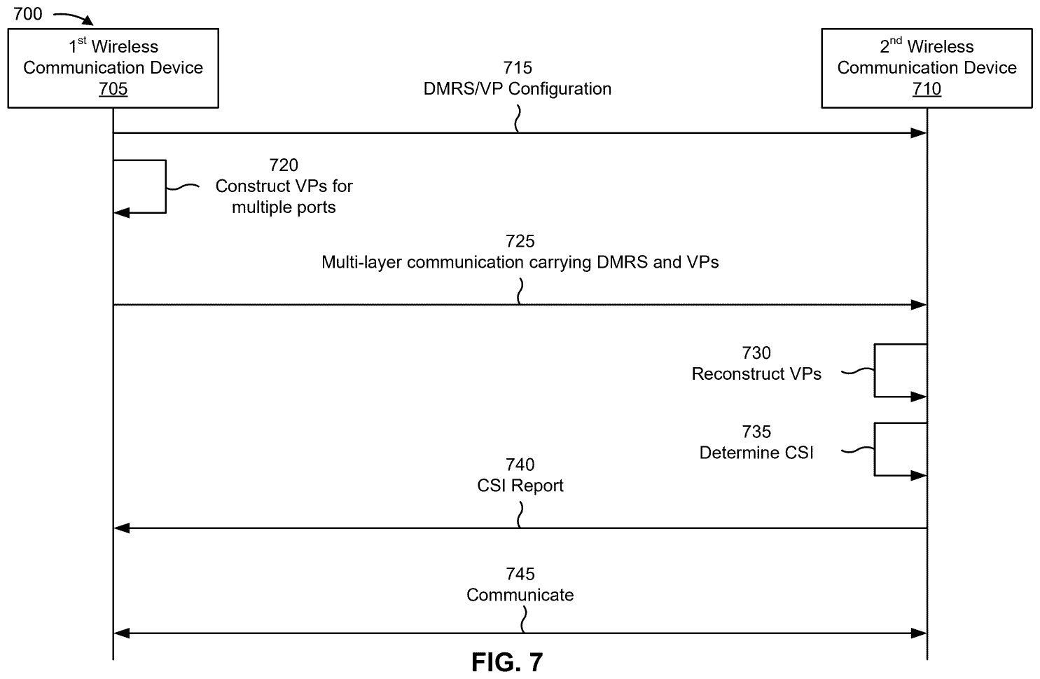

FIGS. 7-11 are diagrams illustrating an example 700 associated with communicating virtual pilots for 6G physical shared channels, in accordance with the present disclosure. As shown in FIG. 7, a first wireless communication device 705 (e.g., a first network node 110, a first UE 120) and a second wireless communication device 710 (e.g., a second network node 110, a second UE 120) may communicate with one another.

As shown by reference number 715, the first wireless communication device 705 may transmit a DMRS/virtual pilot (DMRS/VP) configuration to the second wireless communication device 710.

In some aspects, the DMRS/VP configuration may comprise a single configuration. For example, the DMRS/VP configuration may comprise a DMRS configuration that indicates a set of parameters associated with a DMRS. In these aspects, a set of parameters associated with a set of virtual pilots may correspond to the set of parameters associated with the DMRS.

In some aspects, the DMRS/VP configuration may comprise multiple configurations. For example, the DMRS/VP configuration may include a DMRS configuration and a VP configuration.

In some aspects, the DMRS configuration may be transmitted separately from the VP configuration. In some aspects, the DMRS configuration and the VP configuration may be included in a same communication.

In some aspects, the DMRS configuration and the VP configuration may include a same set of parameters. In some aspects, the DMRS configuration and the VP configuration may comprise different sets of parameters. For example, the DMRS configuration may include one or more additional parameters that are not included in the VP configuration and/or the VP configuration may include one or more additional parameters that are not included in the DMRS configuration.

In some aspects, a value for a parameter included in the DMRS configuration may be the same as a value for a corresponding parameter included in the VP configuration. In some aspects, a value for a parameter included in the DMRS may be different from a value for a corresponding parameter included in the VP configuration. For example, a value for a parameter included in the DMRS (e.g., a DMRS starting symbol location and/or a DMRS symbol spacing) may be different from a value for a corresponding parameter included in the VP configuration (e.g., a virtual pilot starting symbol location and/or a virtual pilot symbol spacing) due to an extra processing delay associated with reconstructing a virtual pilot.

In some aspects, the DMRS/VP configuration may indicate a time location (e.g., a starting OFDM symbol) for the DMRS and/or for the virtual pilots. For example, the DMRS/VP configuration may include a field (a dmrs-TypeA-position field) that indicates a starting DMRS symbol (e.g., a first OFDM symbol via which the DMRS is transmitted) for the DMRS. Additionally, or alternatively, the DMRS/VP configuration may include a field that indicates a starting virtual pilot symbol (e.g., a first OFDM symbol via which a virtual pilot is transmitted).

In some aspects, the DMRS/VP configuration may indicate a quantity of additional DMRS symbols and/or a quantity of additional virtual pilot symbols. For example, the DMRS/VP configuration may include a field (e.g., dmrs-AdditionalPosition field) indicating a number of additional DMRS symbols and/or a field indicating a number of additional virtual pilot symbols.

In some aspects, the second wireless communication device 710 may be configured with an additional DMRS symbol table. The second wireless communication device 710 may derive a location of the additional DMRS symbols from the additional DMRS symbol table based at least in part on a PxSCH duration, a PxSCH mapping type, and the field indicating the number of additional DMRS symbols (e.g., the dmrs-AdditionalPosition field).

In some aspects, a location of a virtual pilot symbol may be indicated by the additional DMRS symbol table. In some aspects, each additional DMRS symbol indicated in the additional DMRS table is replaced by a virtual pilot symbol.

In some aspects, a bit map may indicate one or more of the additional DMRS symbols that are to be replaced by a virtual pilot symbol. For example, the DMRS/VP configuration may indicate a bit map corresponding to the additional DMRS symbol table and/or one or more bits of the bit map corresponding to one or more of the additional DMRS symbols that are to be replaced by a virtual pilot symbol.

In some aspects, the second wireless communication device 710 may be configured with a plurality of bit maps and the DMRS/VP configuration may indicate an index or other information indicating a particular bit map. In some aspects, the DMRS/VP configuration may include the bit map.

In some aspects, a bit in the bit map may be set to a first value (e.g., 1 (one)) to indicate that an additional DMRS symbol indicated by a corresponding bit of the additional DMRS symbol table is to be replaced by a virtual pilot symbol. Additionally, or alternatively, a bit in the bit map may be set to a second value (e.g., 0 (zero)) to indicate that an additional DMRS symbol indicated by a corresponding bit of the additional DMRS symbol table is not to be replaced by a virtual symbol.

Additionally, or alternatively, the second wireless communication device 710 may be configured with an additional virtual pilot symbol table. The second wireless communication device 710 may derive locations of the additional virtual pilot symbols from the additional virtual pilot symbol table based at least in part on a PxSCH duration, a PxSCH mapping type, and the field indicating the number of additional virtual pilot symbols.

In some aspects, the DMRS/VP configuration may indicate frequency locations of DMRS frequency tones and/or frequency locations of virtual pilot tones. The DMRS frequency tones may correspond to frequency tones (e.g., subcarriers) carrying the DMRS. The virtual pilot frequency tones may correspond to frequency tones carrying the virtual pilots.

In some aspects, the DMRS/VP configuration may indicate a type of comb structure associated with the DMRS and/or a type of comb structure associated with the virtual pilots. In some aspects, a comb structure may map different frequency tones to different ports. A type of the comb structure may be associated with a number of ports that are to receive a multi-layer communication and/or a number of layers used to transmit a multi-layer communication. For example, a comb-X structure may be associated with a multi-layer communication that is to be received via X number of ports and/or transmitted via X layers.

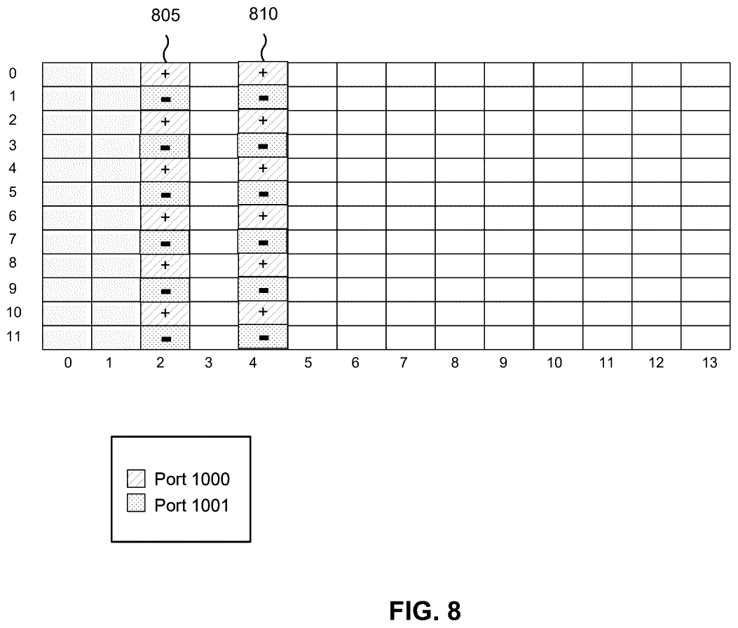

As shown in FIG. 8, the DMRS/VP configuration may be configured for a two-layer communication that includes a first layer and a second layer. In some aspects, a comb structure may correspond to a structure of time and frequency resources of an RB. For example, as shown by reference number 805, a comb structure for an RB carrying a single DMRS symbol may correspond to a column of one time resource and twelve rows of frequency resources. As another example, a comb structure for an RB carrying two DMRSs (not shown) may correspond to two columns of time resources and twelve rows of frequency resources.

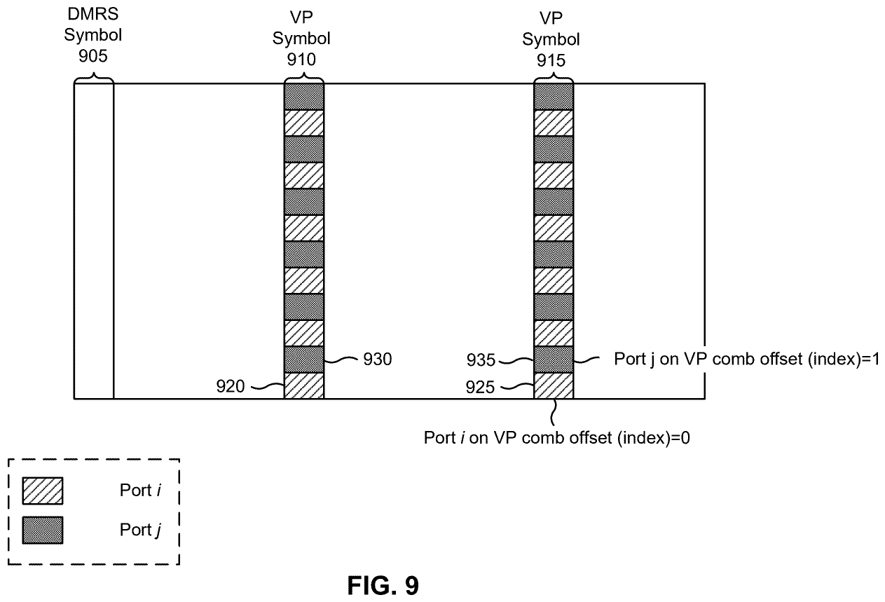

Similarly, as shown by reference number 810, a comb structure for an RB carrying a single virtual pilot symbol may correspond to a column of one time resource and twelve rows of frequency resources. As another example, a comb structure for an RB carrying two virtual pilot symbols (e.g., as shown in FIGS. 9-11) may correspond to two columns of time resources and twelve rows of frequency resources.

As shown in FIG. 8, a comb structure may comprise a comb-2 structure based at least in part on the two-layer communication being received via two ports (e.g., port 1000 and port 1001, as shown in FIG. 8) and/or based on the two-layer communication being transmitted via two layers (e.g., the first layer and the second layer). As shown in FIG. 8, DMRS frequency tones associated with port 1000 comprise every other frequency tone (e.g., even subcarriers, as shown in FIG. 8) of the DMRS symbol and DMRS frequency tones associated with port 1001 comprise the remaining DMRS frequency tones (e.g., odd subcarriers, as shown in FIG. 8) of the DMRS symbol. Similarly, as also shown in FIG. 8, virtual pilot frequency tones associated with port 1000 occupy every other frequency tone (e.g., even subcarriers, as shown in FIG. 8) of the virtual pilot symbol and virtual pilot frequency tones associated with port 1001 occupy the remaining virtual pilot frequency tones (e.g., odd subcarriers, as shown in FIG. 8) of the virtual pilot symbol.

In some aspects, the DMRS/VP configuration may indicate a DMRS comb index and/or a virtual pilot comb index associated with each port. In some aspects, a DMRS comb index may indicate a first DMRS frequency tone for each port. For example, the DMRS/VP configuration may indicate a comb index of 0 for port 1000 and a comb index of 1 for port 1001. The pattern indicated by the comb indexes may repeat in a similar manner for the remaining DMRS frequency tones.

For example, the second wireless communication device 710 may determine that a first DMRS frequency tone (e.g., subcarrier 11, as shown in FIG. 8) is associated with port 1000 based at least in part on the DMRS/VP configuration indicating a DMRS comb index of 0 for port 1000. The second wireless communication device 710 may determine that a second DMRS frequency tone (e.g., subcarrier 10, as shown in FIG. 8) is associated with port 1001 based at least in part on the DMRS/VP configuration indicating a DMRS comb index of 1 for port 1001.

In some aspects, the second wireless communication device 710 may determine that a DMRS comb pattern corresponds to alternating DMRS frequency tones based at least in part on the first DMRS frequency tone being associated with port 1000 and the second DMRS frequency tone being associated with port 1001.

In cases where the DMRS frequency tones are associated with more than 2 ports, the additional DMRS frequency tones may be indicated in a similar manner. For example, the DMRS/VP configuration may indicate a comb index of 2 to indicate that a third port is associated with a third DMRS frequency tone (e.g., subcarrier 9, as shown in FIG. 8), a comb index of 3 to indicate that a fourth port is associated with a fourth DMRS frequency tone (e.g., subcarrier 8, as shown in FIG. 8), and so on.

In some aspects, a virtual pilot comb index may indicate a first virtual pilot frequency tone for each port. For example, the DMRS/VP configuration may indicate a virtual pilot comb index of 0 for port 1000 and a virtual pilot comb index of 1 for port 1001. The pattern indicated by the virtual pilot comb indexes may repeat in a similar manner for the remaining virtual pilot frequency tones, in a manner similar to that described above with respect to the DMRS frequency tones.

In some aspects, the DMRS/VP configuration may indicate an orthogonal cover code (OCC) associated with the DMRS and/or an OCC associated with the virtual pilots. In some aspects, the OCC may comprise a time-domain OCC. Additionally, or alternatively, the OCC may comprise a frequency-domain OCC.

In some aspects, an OCC matrix may be used to support multi-layer communications. Each wireless communication device may apply a particular vector (column of entries) of the OCC matrix and associate the particular vector with a port (e.g., a DMRS port and/or a virtual pilot port). For example, one OCC vector may be drawn from an OCC matrix and applied to a first port (e.g., port 1000, as shown in FIG. 8). Another OCC vector may be drawn from the same or another OCC matrix and applied to a second port (e.g., port 1001, as shown in FIG. 8). An OCC matrix may be any suitable type of orthogonal matrix, such as a discrete Fourier transform (DFT) matrix. The + and − characters shown in FIG. 8 represent an OCC applied to a DMRS transmission, a DMRS sequence, a virtual pilot transmission, or a virtual pilot sequency in a particular resource element, where an OCC represented by a + character is different from an OCC represented by a − character.

In some aspects, the DMRS/VP configuration may indicate a number of contiguous DMRS symbols and/or a number of contiguous virtual pilot symbols. In some aspects, the number of contiguous DMRS symbols may be the same as the number of contiguous virtual pilot symbols. In some aspects, the number of contiguous DMRS symbols may be different from the number of contiguous virtual pilot symbols.

With reference now to FIG. 7, in some aspects, the first wireless communication device 705 may generate a multi-layer communication to be transmitted to the second wireless communication device 710 via a PxSCH based at least in part on transmitting the DMRS/VP configuration to the second wireless communication device 710. For example, the first wireless communication device 705 may generate a multi-layer communication for transmission to the second wireless communication device 710 via a PUSCH or a PDSCH based at least in part on transmitting the DMRS/VP configuration to the second wireless communication device 710, receiving an ACK indicating that the second wireless communication device 710 successfully received and decoded the DMRS/VP configuration, and/or not receiving a NACK indicating that the second wireless communication device 710 failed to successfully receive and/or decode the DMRS/VP configuration.

In some aspects, the multi-layer communication may include a DMRS to enable the second wireless communication device 710 to perform channel estimation for a PxSCH. For example, the DMRS may carry information used to estimate a radio channel (e.g., the PxSCH) for demodulation of the multi-layer communication.

As shown by reference number 720, the first wireless communication device 705 may construct a set of virtual pilots (e.g., a set of virtual pilot tones and/or a set of virtual pilot symbols) to aid the second wireless communication device 710 in performing channel estimation for the PxSCH.

In some aspects, the set of virtual pilots may be mapped to data frequency tones (e.g., frequency tones allocated for carrying data rather than DMRS). In some aspects, the first wireless communication device 705 may map virtual pilots to be transmitted via different layers of the multi-layer communication and/or to be received via different ports of the second wireless communication device 710 to different virtual pilot comb offsets corresponding to different virtual pilot comb indexes.

For example, as shown in FIG. 9, an RB for a two-layer communication may include a DMRS symbol 905, a first virtual pilot symbol 910 and a second virtual pilot symbol 915. The first wireless communication device 705 may map virtual pilot frequency tones (e.g., virtual pilot frequency tones 920, 925, as shown in FIG. 9) associated with a first port (e.g., port i, as shown in FIG. 9) to a first virtual pilot comb offset corresponding to a first virtual pilot comb index (e.g., VP comb offset (index) 0, as shown in FIG. 9). The first wireless communication device 705 may map virtual pilot frequency tones (e.g., virtual pilot frequency tones 930, 935, as shown in FIG. 9) associated with a second port (e.g., port j, as shown in FIG. 9) to a second virtual pilot comb offset corresponding to a second virtual pilot comb index (e.g., VP comb offset (index) 1, as shown in FIG. 9). Mapping virtual pilot frequency tones associated with different ports to different virtual pilot comb offsets, may cause the received frequency-domain IQ samples of one layer of the multi-layer communication to be orthogonal to the received frequency-domain IQ samples of another layer of the multi-layer communication.

In some aspects, the first wireless communication device 705 may construct the virtual pilots such that data frequency tones carrying virtual pilot frequency tones for each layer of the multi-layer communication are orthogonal to data frequency tones carrying virtual pilot frequency tones for each other layer of the multi-layer communication.

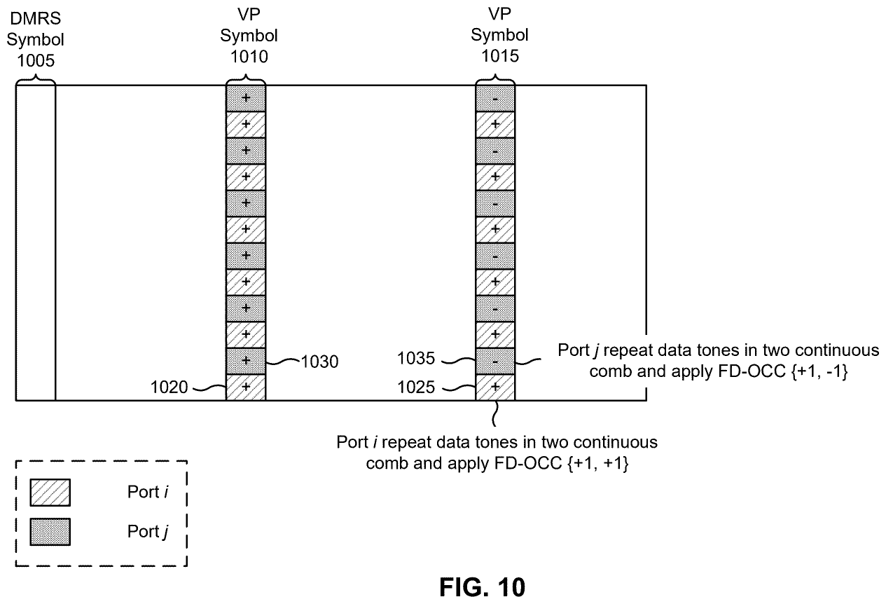

In some aspects, the first wireless communication device 705 may apply a frequency-domain OCC to the virtual pilot frequency tones. As shown in FIG. 10, an RB for the multi-layer communication may include a DMRS symbol 1005, a first virtual pilot symbol 1010, and a second virtual pilot symbol 1015.

In some aspects, the first wireless communication device 705 may repeat un-precoded data frequency tones for each port in two continuous combs. For example, for each layer of X-layer communication (where X is an integer greater than 1), un-precoded data frequency data tones carrying virtual pilot frequency tones may be repeated X times.

In some aspects, the first wireless communication device 705 may apply frequency-domain OCC to the repeated data frequency tones (e.g., the virtual pilot frequency tones). In some aspects, the first wireless communication device 705 may apply different frequency-domain OCC for virtual pilot frequency tones associated with different ports.

For example, for an X-layer communication, the first wireless communication device 705 may apply frequency-domain OCC-X, where OCC-X corresponds to an X by one OCC vector from a corresponding OCC matrix. Stated differently, the i-th layer data bearing VP in X frequency tones is given by xᵢ=qᵢ·wᵢ, where wᵢ is the X by 1 frequency-domain OCC vector and q; is the data bearing QAM symbol.

For example, the first wireless communication device 705 may map virtual pilot frequency tones (e.g., virtual pilot frequency tones 1020, 1025, as shown in FIG. 10) associated with a first port (e.g., port i, as shown in FIG. 10) to a first virtual pilot comb offset corresponding to a first virtual pilot comb index (e.g., VP comb offset (index) 0, as shown in FIG. 10).

In some aspects, the first wireless communication device 705 may repeat the data frequency tone corresponding to a comb index of 0 in the virtual pilot symbol 1010 and the virtual pilot symbol 1015. The first wireless communication device 705 may apply a first frequency-domain OCC to the virtual pilot frequency tone 1020 and to the virtual pilot frequency tone 1025.

The first wireless communication device 705 may map virtual pilot frequency tones (e.g., virtual pilot frequency tones 1030, 1035, as shown in FIG. 10) associated with a second port (e.g., port j, as shown in FIG. 10) to a second virtual pilot comb offset corresponding to a second virtual pilot comb index (e.g., VP comb offset (index) 1, as shown in FIG. 10).

In some aspects, the first wireless communication device 705 may repeat the data frequency tone corresponding to a comb index of 1 in the virtual pilot symbol 1010 and the virtual pilot symbol 1015. The first wireless communication device 705 may apply the first frequency-domain OCC to the virtual pilot frequency tone 1030 and may apply a second frequency-domain OCC to the virtual pilot frequency tone 1035. In some aspects, transmission precoding may be applied to the multi-layer communication after applying the frequency domain-OCC to the virtual pilot frequency tones. By utilizing frequency-domain OCC as described above,

$${x}_{i}^{H} \cdot {x}_{j} = 0$$

and virtual pilots from different layers may be orthogonal in the frequency-code-domain.

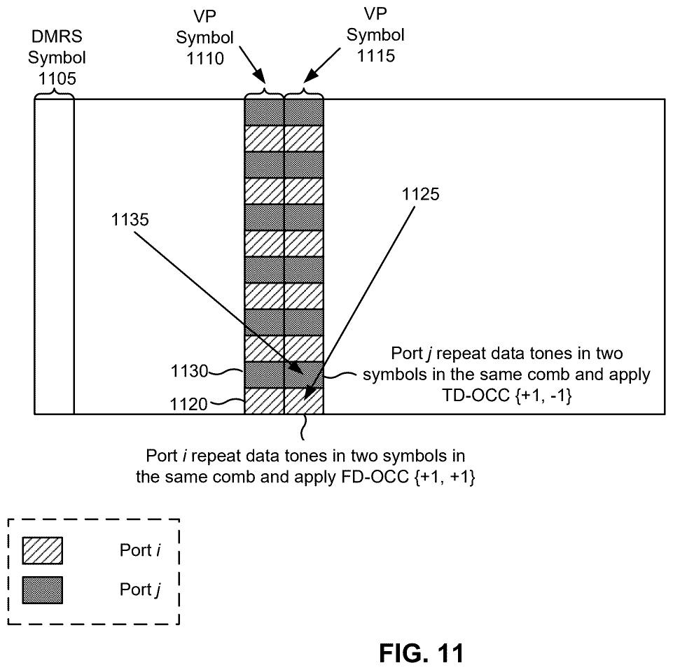

In some aspects, the first wireless communication device 705 may apply time-domain OCC to the virtual pilot frequency tones. As shown in FIG. 11, an RB for the multi-layer communication may include a DMRS symbol 1105, a first virtual pilot symbol 1110, and a second virtual pilot symbol 1115.

The first wireless communication device 705 may map virtual pilot frequency tones (e.g., virtual pilot frequency tones 1130, 1135, as shown in FIG. 11) associated with a second port (e.g., port j, as shown in FIG. 11) to a second virtual pilot comb offset corresponding to a second virtual pilot comb index (e.g., VP comb offset (index) 1, as shown in FIG. 11).

In some aspects, the first wireless communication device 705 may repeat un-precoded data frequency tones for each port in two continuous combs. For example, for each layer of X-layer communication (where X is an integer greater than 1), un-precoded data frequency data tones carrying virtual pilot frequency tones may be repeated X times.

For example, the first wireless communication device 705 may map virtual pilot frequency tones (e.g., virtual pilot frequency tones 1120, 1125, as shown in FIG. 11) associated with a first port (e.g., port i, as shown in FIG. 11) to a first virtual pilot comb offset corresponding to a first virtual pilot comb index (e.g., VP comb offset (index) 0, as shown in FIG. 11).

In some aspects, the first wireless communication device 705 may repeat the data frequency tone corresponding to a comb index of 0 in the virtual pilot symbol 1110 and the virtual pilot symbol 1115. The first wireless communication device 705 may apply a first time-domain OCC to the virtual pilot frequency tone 1120 and to the virtual pilot frequency tone 1125.

In some aspects, the first wireless communication device 705 may apply time-domain OCC to the repeated data frequency tones (e.g., the virtual pilot frequency tones). In some aspects, the first wireless communication device 705 may apply different time-domain OCC for virtual pilot frequency tones associated with different ports.

For example, for an N-layer communication, the first wireless communication device 705 may apply a time-domain OCC-X, where OCC-X corresponds to an N by one OCC vector (X) from a corresponding OCC matrix. Stated differently, the i-th layer data bearing virtual pilot in N frequency tones is given by xᵢ=qᵢ·w_{T,i}, where w_{T,i} is the N by 1 time-domain OCC vector (X) and qᵢ is the data bearing QAM symbol. In some aspects, the first wireless communication device 705 may apply transmission precoding to the multi-layer communication after applying the time-domain OCC.

By utilizing a time-domain OCC as described above,

$${X}_{i}^{H} \cdot {X}_{j} = 0$$

and virtual pilots from two layers may be orthogonal in the frequency-code-domain.

As shown in FIG. 7, and by reference number 725, the first wireless communication device 705 may transmit, and the second wireless communication device 710 may receive, the multi-layer communication carrying the DMRS and the virtual pilots. In some aspects, the second wireless communication device 710 may decode the received multi-layer communication based at least in part on receiving the multi-layer communication from the first wireless communication device 705.

As shown by reference number 730, the second wireless communication device 710 may reconstruct the virtual pilots included in the multi-layer communication. In some aspects, the second wireless communication device 710 may utilize an LS method to reconstruct the virtual pilots. For example, the second wireless communication device 710 may identify the virtual pilot symbols based at least in part on the DMRS/VP configuration.

In some aspects, the second wireless communication device 710 may identify the virtual pilot frequency tones associated with each port via which the multi-layer communication was received. In some aspects, the second wireless communication device 710 may determine a respective comb index associated with each port. For example, the second wireless communication device 710 may determine the comb index associated with each port based at least in part on the DMRS/VP configuration, in a manner similar to that described above. The second wireless communication device 710 may identify the virtual pilot frequency tones associated with each port based at least in part on the respective comb indexes.

In some aspects, the second wireless communication device 710 may reconstruct the virtual pilots on a per port basis based at least in part on identifying the virtual pilot frequency tones associated with each port. For example, the second wireless communication device 710 may reconstruct a virtual pilot received via a first port using the virtual pilot frequency tones associated with the first port. The second wireless communication device 710 may reconstruct a virtual pilot received via a second port using the virtual pilot frequency tones associated with the second port. The second wireless communication device 710 may continue in a similar manner for each port via which the multi-layer communication was received.

In some aspects, the second wireless communication device 710 may perform the LS method to reconstruct the virtual pilots for each port. For example, for a first port associated with the virtual pilot comb offset (index) k, the second wireless communication device 710 reconstruct the virtual pilot received via the first port based on the following equation:

$${H}_{vp , k} = b \cdot {\tilde{X}}^{H} Y = b \cdot [ {\tilde{x}}_{k}^{H} ] \cdot ( {x}_{k} {h}_{k}^{T} + Z ) ,$$

wherein H_{vp,k} corresponds to the virtual pilot, Y corresponds to the input frequency domain symbols, X corresponds to the reconstructed QAM constellation carrying data, \tilde{X}^{H} corresponds to the reconstructed QAM constellation carrying the virtual pilots, b corresponds to a regularization factor,

$${\tilde{x}}_{k}^{H}$$

corresponds to a virtual pilot frequency tone, xₖ corresponds to the received frequency tone,

$${h}_{k}^{T}$$

corresponds to the virtual pilot frequency tone, and Z corresponds to noise associated with receiving the multi-layer communication via the first port.

In some aspects, the multi-layer communication may include repeated data frequency tones for each port in two continuous combs and with frequency-domain OCC applied to the repeated data tones, as described above with respect to FIG. 10. In these aspects, the second wireless communication device 710 may reconstruct the virtual pilot frequency tones for two layers as:

$$Layer 0 : {x}_{0} = [ \begin{matrix}1 \\ 1\end{matrix} ] {q}_{o} and layer 1 -> {x}_{1} = [ \begin{matrix}1 \\ - 1\end{matrix} ] {q}_{1} ,$$

where qᵢ corresponds to the QAM data symbols for the i-th layer of the multi-layer communication. In this way, the descrambled virtual pilot can be reconstructed as:

$${H}_{vp} = b \cdot {\tilde{X}}^{H} Y = b \cdot [ \begin{matrix}{\tilde{x}}_{0}^{H} \\ {\tilde{x}}_{1}^{H}\end{matrix} ] \cdot ( {x}_{0} {h}_{0}^{T} + {x}_{1} {h}_{1}^{T} + Z ) = b \cdot [ \begin{matrix}{\tilde{x}}_{0}^{H} {x}_{0} {h}_{0}^{T} + {\tilde{x}}_{0}^{H} {x}_{1} {h}_{1}^{T} \\ {\tilde{x}}_{1}^{H} {x}_{0} {h}_{0}^{T} + {\tilde{x}}_{1}^{H} {x}_{1} {h}_{1}^{T}\end{matrix} ] + {Z}^{′} = b \cdot [ \begin{matrix}{\vert {q}_{0} \vert}^{2} {h}_{0}^{T} \\ {\vert {q}_{1} \vert}^{2} {h}_{1}^{T}\end{matrix} ] + {Z}^{′} .$$

In some aspects, the multi-layer communication may include repeated data frequency tones for each port in two continuous combs and with time-domain OCC applied to the repeated data tones, as described above with respect to FIG. 11. In these aspects, the second wireless communication device 710 may reconstruct the virtual pilot frequency tones. For example, a multi-layer communication comprising two layers may be represented as X₀=q₀[1 1]^{T} and X₁=q₀[1−1]^{T} where q₀s are the data bearing QAM symbols and Xᵢ is the i-th layer's virtual pilots in two consecutive symbols after time-domain OCC is applied. The virtual pilots may be reconstructed as:

$${H}_{vp} = b \cdot [ \begin{matrix}{\tilde{X}}_{0}^{H} {X}_{0} {H}_{0} + {\tilde{X}}_{0}^{H} {X}_{1} {H}_{1} \\ {\tilde{X}}_{1}^{H} {X}_{0} {H}_{0} + {\tilde{X}}_{1}^{H} {X}_{1} {H}_{1}\end{matrix} ] + Z = b \cdot [ \begin{matrix}{\tilde{X}}_{0}^{H} {X}_{0} {H}_{0} \\ {\tilde{X}}_{1}^{H} {X}_{1} {H}_{1}\end{matrix} ] + Z = {b}^{′} [ \begin{matrix}{H}_{0} \\ {H}_{1}\end{matrix} ] + Z .$$

In some aspects, the second wireless communication device 710 may perform channel estimation for the PxSCH based at least in part on the DMRS and/or the reconstructed virtual pilots. For example, as shown in FIG. 7, and by reference number 735, the second wireless communication device 710 may determine CSI for the PxSCH based at least in part on the DMRS and the reconstructed virtual pilots.

In some aspects, the second wireless communication device 710 may transmit information indicating the channel estimation for the PxSCH to the first wireless communication device 705. For example, as shown by reference number 740, the second wireless communication device 710 may transmit a CSI report to the first wireless communication device 705. As shown by reference number 745, the first wireless communication device 705 and the second wireless communication device 710 may communicate. For example, the first wireless communication device 705 and/or the second wireless communication device 710 may determine one or more communication parameters based at least in part the information indicating the channel estimation.

As indicated above, FIGS. 7-11 are provided as examples. Other examples may differ from what is described with respect to FIGS. 7-11.

FIG. 12 is a diagram illustrating an example process 1200 performed, for example, at a wireless communication device (e.g., a network node 110, a UE 120) or an apparatus of a wireless communication device, in accordance with the present disclosure. Example process 1200 is an example where the apparatus or the wireless communication device (e.g., wireless communication device 710) performs operations associated with patterns of virtual pilots for 6G physical shared channels.

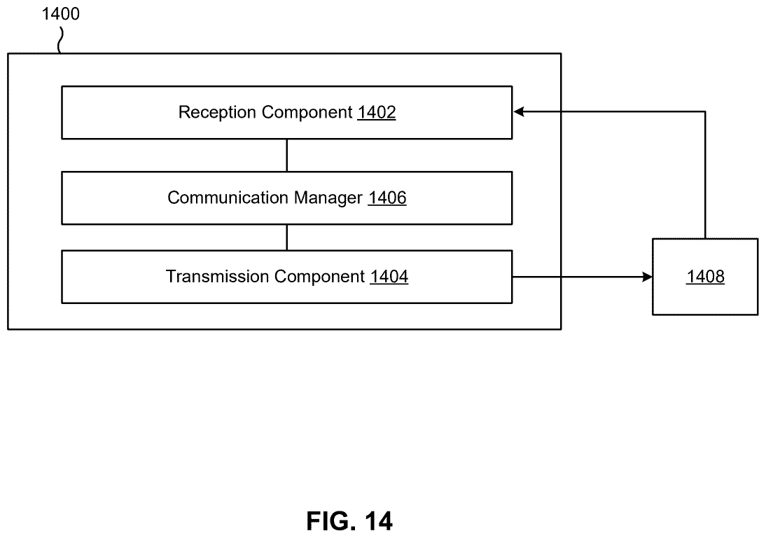

As shown in FIG. 12, in some aspects, process 1200 may include receiving, via a first port, a first layer of a multi-layer communication, wherein data carrying first virtual pilots associated with the first layer is carried in a first set of data tones associated with a first comb offset of a frequency-domain comb structure (block 1210). For example, the wireless communication device (e.g., using reception component 1402 and/or communication manager 1406, depicted in FIG. 14) may receive, via a first port, a first layer of a multi-layer communication, wherein data carrying first virtual pilots associated with the first layer is carried in a first set of data tones associated with a first comb offset of a frequency-domain comb structure, as described above.

As further shown in FIG. 12, in some aspects, process 1200 may include receiving, via a second port, a second layer of the multi-layer communication, wherein data carrying second virtual pilots associated with the second layer is carried in a second set of data tones associated with a second comb offset of the frequency-domain comb structure (block 1220). For example, the wireless communication device (e.g., using reception component 1402 and/or communication manager 1406, depicted in FIG. 14) may receive, via a second port, a second layer of the multi-layer communication, wherein data carrying second virtual pilots associated with the second layer is carried in a second set of data tones associated with a second comb offset of the frequency-domain comb structure, as described above.

Process 1200 may include additional aspects, such as any single aspect or any combination of aspects described below and/or in connection with one or more other processes described elsewhere herein.

In a first aspect, the frequency domain comb structure comprises a comb-2 structure, and the first virtual pilots are carried in every other frequency tone of the comb-2 structure.

In a second aspect, alone or in combination with the first aspect, process 1200 includes reconstructing the multi-layer communication per port based at least in part on the first comb offset and the second comb offset.

In a third aspect, alone or in combination with one or more of the first and second aspects, the first set of data tones are orthogonal to the second set of data tones.

In a fourth aspect, alone or in combination with one or more of the first through third aspects, a data tone is repeated in two continuous tones of the frequency-domain comb structure, and a frequency-domain orthogonal cover code is applied to the two continuous tones.

In a fifth aspect, alone or in combination with one or more of the first through fourth aspects, the data carrying the first set of virtual pilots and the data carrying the second set of virtual pilots are repeated in frequency tones for each layer of the multi-layer communication, and a first frequency-domain OCC (FD-OCC) is applied to the data carrying the first set of virtual pilots and a second, different FD-OCC is applied to the data carrying the second set of virtual pilots.

In a sixth aspect, alone or in combination with one or more of the first through fifth aspects, for each layer, of the multi-layer communication, un-precoded data is repeated X times, where X is an integer, and a corresponding FD-OCC-X is applied on the first set of virtual pilots and the second set of virtual pilots.

In a seventh aspect, alone or in combination with one or more of the first through sixth aspects, transmission precoding is applied after applying the first FD-OCC and the second FD-OCC.

In an eighth aspect, alone or in combination with one or more of the first through seventh aspects, the first set of virtual pilots and the second set of virtual pilots are repeated in a set of symbols, and a first time-domain OCC (TD-OCC) is applied to the first set of virtual pilots and a second, different TD-OCC is applied to the second set of virtual pilots.

In a ninth aspect, alone or in combination with one or more of the first through eighth aspects, for each layer, of the multi-layer communication, un-precoded data is repeated X-times, where X is an integer, and a corresponding TD-OCC-X is applied on the first set of virtual pilots and the second set of virtual pilots.

In a tenth aspect, alone or in combination with one or more of the first through ninth aspects, process 1200 includes receiving information indicating a DMRS configuration, wherein the frequency-domain comb structure is based at least in part on the DMRS configuration.

In an eleventh aspect, alone or in combination with one or more of the first through tenth aspects, a time and frequency structure of the first set of virtual pilots and the second set of virtual pilots is based at least in part on a demodulation reference signal configuration.

In a twelfth aspect, alone or in combination with one or more of the first through eleventh aspects, process 1200 includes generating a port mapping table based at least in part on the time and frequency structure of the first set of virtual pilots and the second set of virtual pilots, and determining at least one of the first comb offset or the second comb offset based at least in part on at least one of a first port index associated with the first port or a second port index associated with the second port.

In a thirteenth aspect, alone or in combination with one or more of the first through twelfth aspects, process 1200 includes receiving downlink control information (DCI) indicating a port index associated with the multi-layer communication.

In a fourteenth aspect, alone or in combination with one or more of the first through thirteenth aspects, a virtual pilot configuration corresponds to a demodulation reference signal configuration.

In a fifteenth aspect, alone or in combination with one or more of the first through fourteenth aspects, the multi-layer communication includes a DMRS, and the first set of virtual pilots and the DMRS have one or more of a same comb structure, a same comb offset, a same frequency-domain OCC, a same time-domain OCC, and a same number of contiguous symbols.

In a sixteenth aspect, alone or in combination with one or more of the first through fifteenth aspects, process 1200 includes receiving a virtual pilot configuration, wherein the virtual pilot configuration indicates one or more of a demodulation reference signal type, a port to comb mapping, a port to time-domain OCC mapping, a port to frequency-domain OCC mapping, or a number of contiguous virtual pilot symbols.

In a seventeenth aspect, alone or in combination with one or more of the first through sixteenth aspects, process 1200 includes receiving a DMRS configuration, wherein the DMRS configuration indicates a DMRS symbol that is replaced by a virtual pilot symbol.

In an eighteenth aspect, alone or in combination with one or more of the first through seventeenth aspects, a bitmap is used to indicate the DMRS symbol that is replaced by the virtual pilot symbol.

In a nineteenth aspect, alone or in combination with one or more of the first through eighteenth aspects, the configuration indicates a starting symbol index from which the DMRS symbol, and later DMRS symbols, are replaced with virtual pilot symbols.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a wireless communication device (e.g., a network node 110, a UE 120) or an apparatus of a wireless communication device, in accordance with the present disclosure. Example process 1300 is an example where the apparatus or the wireless communication device (e.g., wireless communication device 705) performs operations associated with patterns of virtual pilots for 6G physical shared channels.

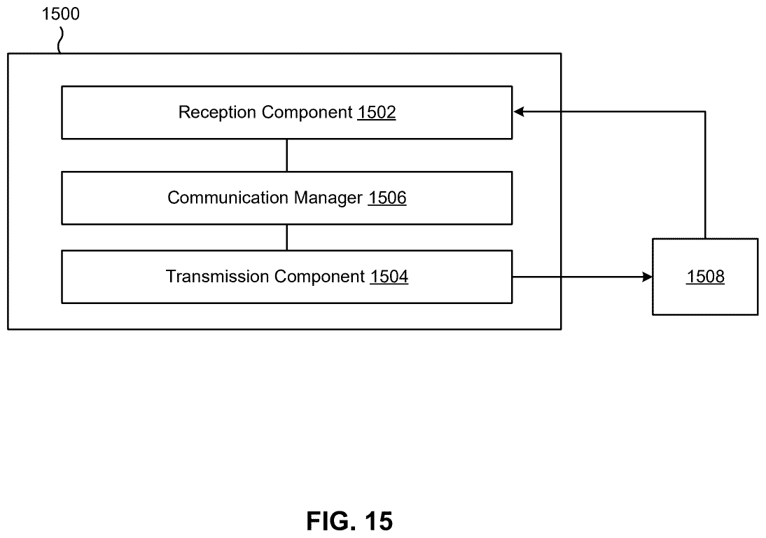

As shown in FIG. 13, in some aspects, process 1300 may include transmitting, via a first port, a first layer of a multi-layer communication, wherein data carrying first virtual pilots associated with the first layer is carried in a first set of data tones associated with a first comb offset of a frequency-domain comb structure (block 1310). For example, the wireless communication device (e.g., using transmission component 1504 and/or communication manager 1506, depicted in FIG. 15) may transmit, via a first port, a first layer of a multi-layer communication, wherein data carrying first virtual pilots associated with the first layer is carried in a first set of data tones associated with a first comb offset of a frequency-domain comb structure, as described above.

As further shown in FIG. 13, in some aspects, process 1300 may include transmitting, via a second port, a second layer of the multi-layer communication, wherein data carrying second virtual pilots associated with the second layer is carried in a second set of data tones associated with a second comb offset of the frequency-domain comb structure (block 1320). For example, the wireless communication device (e.g., using transmission component 1504 and/or communication manager 1506, depicted in FIG. 15) may transmit, via a second port, a second layer of the multi-layer communication, wherein data carrying second virtual pilots associated with the second layer is carried in a second set of data tones associated with a second comb offset of the frequency-domain comb structure, as described above.

Process 1300 may include additional aspects, such as any single aspect or any combination of aspects described below and/or in connection with one or more other processes described elsewhere herein.

In a first aspect, the frequency domain comb structure comprises a comb-2 structure, and the first virtual pilots are carried in every other frequency tone of the comb-2 structure.

In a second aspect, alone or in combination with the first aspect, process 1300 includes constructing the multi-layer communication per port based at least in part on the first comb offset and the second comb offset.

In a third aspect, alone or in combination with one or more of the first and second aspects, the first set of data tones are orthogonal to the second set of data tones.

In a fourth aspect, alone or in combination with one or more of the first through third aspects, a data tone is repeated in two continuous tones of the frequency-domain comb structure, and a frequency-domain orthogonal cover code is applied to the two continuous tones.

In a fifth aspect, alone or in combination with one or more of the first through fourth aspects, the data carrying the first set of virtual pilots and the data carrying the second set of virtual pilots are repeated in frequency tones for each layer of the multi-layer communication, and a first FD-OCC is applied to the data carrying the first set of virtual pilots and a second, different FD-OCC is applied to the data carrying the second set of virtual pilots.

In a sixth aspect, alone or in combination with one or more of the first through fifth aspects, for each layer, of the multi-layer communication, un-precoded data is repeated X times, where X is an integer, and a corresponding FD-OCC-X is applied on the first set of virtual pilots and the second set of virtual pilots.

In a seventh aspect, alone or in combination with one or more of the first through sixth aspects, transmission precoding is applied after applying the first FD-OCC and the second FD-OCC.

In an eighth aspect, alone or in combination with one or more of the first through seventh aspects, the first set of virtual pilots and the second set of virtual pilots are repeated in a set of symbols, and a first time-domain OCC is applied to the first set of virtual pilots and a second, different TD-OCC is applied to the second set of virtual pilots.

In a ninth aspect, alone or in combination with one or more of the first through eighth aspects, for each layer, of the multi-layer communication, un-precoded data is repeated X-times, where X is an integer, and a corresponding TD-OCC-X is applied on the first set of virtual pilots and the second set of virtual pilots.

In a tenth aspect, alone or in combination with one or more of the first through ninth aspects, process 1300 includes transmitting information indicating a DMRS configuration, wherein the frequency-domain comb structure is based at least in part on the DMRS configuration.

In an eleventh aspect, alone or in combination with one or more of the first through tenth aspects, a time and frequency structure of the first set of virtual pilots and the second set of virtual pilots is based at least in part on a demodulation reference signal configuration.

In a twelfth aspect, alone or in combination with one or more of the first through eleventh aspects, process 1300 includes transmitting DCI indicating a port index associated with the multi-layer communication.

In a thirteenth aspect, alone or in combination with one or more of the first through twelfth aspects, a virtual pilot configuration corresponds to a demodulation reference signal configuration.

In a fourteenth aspect, alone or in combination with one or more of the first through thirteenth aspects, the multi-layer communication includes a DMRS, and the first set of virtual pilots and the DMRS have one or more of a same comb structure, a same comb offset, a same frequency-domain OCC, a same time-domain OCC, and a same number of contiguous symbols.

In a fifteenth aspect, alone or in combination with one or more of the first through fourteenth aspects, process 1300 includes transmitting a virtual pilot configuration, wherein the virtual pilot configuration indicates one or more of a demodulation reference signal type, a port to comb mapping, a port to time-domain OCC mapping, a port to frequency-domain OCC mapping, or a number of contiguous virtual pilot symbols.

In a sixteenth aspect, alone or in combination with one or more of the first through fifteenth aspects, process 1300 includes transmitting a DMRS configuration, wherein the DMRS configuration indicates a DMRS symbol that is replaced by a virtual pilot symbol.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a wireless communication device (e.g., network node 110, UE 120, second wireless communication device 710), or a wireless communication device may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12, process 1300 of FIG. 13, or a combination thereof. In some aspects, the apparatus 1400 and/or one or more components shown in FIG. 14 may include one or more components of the network node and/or the UE described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node and/or the UE described in connection with FIG. 1 and FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node and/or the UE described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, via a first port, a first layer of a multi-layer communication, wherein data carrying first virtual pilots associated with the first layer is carried in a first set of data tones associated with a first comb offset of a frequency-domain comb structure. The reception component 1402 may receive, via a second port, a second layer of the multi-layer communication, wherein data carrying second virtual pilots associated with the second layer is carried in a second set of data tones associated with a second comb offset of the frequency-domain comb structure.

The communication manager 1406 may reconstruct the multi-layer communication per port based at least in part on the first comb offset and the second comb offset.

The reception component 1402 may receive information indicating a DMRS configuration, wherein the frequency-domain comb structure is based at least in part on the DMRS configuration.

The communication manager 1406 may generate a port mapping table based at least in part on the time and frequency structure of the first set of virtual pilots and the second set of virtual pilots.

The communication manager 1406 may determine at least one of the first comb offset or the second comb offset based at least in part on at least one of a first port index associated with the first port or a second port index associated with the second port.

The reception component 1402 may receive DCI indicating a port index associated with the multi-layer communication.

The reception component 1402 may receive a virtual pilot configuration, wherein the virtual pilot configuration indicates one or more of: a demodulation reference signal type, a port to comb mapping, a port to time-domain OCC mapping, a port to frequency-domain OCC mapping, or a number of contiguous virtual pilot symbols.

The reception component 1402 may receive a DMRS configuration, wherein the DMRS configuration indicates a DMRS symbol that is replaced by a virtual pilot symbol.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a wireless communication device (e.g., network node 110, UE 120, second wireless communication device 710), or a wireless communication device may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 7-11. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the network node and/or the UE described in connection with FIG. 1 and FIG. 2. Additionally, or alternatively, one or more components shown in FIG. 15 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node and/or the UE described in connection with FIG. 1 and FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the network node and/or the UE described in connection with FIG. 1 and FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive, via a first port, a first layer of a multi-layer communication, wherein data carrying first virtual pilots associated with the first layer is carried in a first set of data tones associated with a first comb offset of a frequency-domain comb structure. The reception component 1502 may receive, via a second port, a second layer of the multi-layer communication, wherein data carrying second virtual pilots associated with the second layer is carried in a second set of data tones associated with a second comb offset of the frequency-domain comb structure.

The communication manager 1506 may reconstruct the multi-layer communication per port based at least in part on the first comb offset and the second comb offset.

The transmission component 1504 may transmit information indicating a DMRS configuration, wherein the frequency-domain comb structure is based at least in part on the DMRS configuration.

The communication manager 1506 may generate a port mapping table based at least in part on the time and frequency structure of the first set of virtual pilots and the second set of virtual pilots.

The communication manager 1506 may determine at least one of the first comb offset or the second comb offset based at least in part on at least one of a first port index associated with the first port or a second port index associated with the second port.

The transmission component 1504 may transmit DCI indicating a port index associated with the multi-layer communication.

The transmission component 1504 may transmit a virtual pilot configuration, wherein the virtual pilot configuration indicates one or more of: a demodulation reference signal type, a port to comb mapping, a port to time-domain OCC mapping, a port to frequency-domain OCC mapping, or a number of contiguous virtual pilot symbols.

The transmission component 1504 may transmit a DMRS configuration, wherein the DMRS configuration indicates a DMRS symbol that is replaced by a virtual pilot symbol.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a wireless communication device, comprising: receiving, via a first port, a first layer of a multi-layer communication, wherein data carrying first virtual pilots associated with the first layer is carried in a first set of data tones associated with a first comb offset of a frequency-domain comb structure; and receiving, via a second port, a second layer of the multi-layer communication, wherein data carrying second virtual pilots associated with the second layer is carried in a second set of data tones associated with a second comb offset of the frequency-domain comb structure.

Aspect 2: The method of Aspect 1, wherein the frequency domain comb structure comprises a comb-2 structure, and wherein the first virtual pilots are carried in every other frequency tone of the comb-2 structure.

Aspect 3: The method of any of Aspects 1-2, further comprising: reconstructing the multi-layer communication per port based at least in part on the first comb offset and the second comb offset.

Aspect 4: The method of any of Aspects 1-3, wherein the first set of data tones are orthogonal to the second set of data tones.

Aspect 5: The method of any of Aspects 1-4, wherein a data tone is repeated in two continuous tones of the frequency-domain comb structure, and a frequency-domain OCC is applied to the two continuous tones.

Aspect 6: The method of any of Aspects 1-5, wherein the data carrying the first set of virtual pilots and the data carrying the second set of virtual pilots are repeated in frequency tones for each layer of the multi-layer communication, and wherein a first frequency-domain OCC (FD-OCC) is applied to the data carrying the first set of virtual pilots and a second, different FD-OCC is applied to the data carrying the second set of virtual pilots.

Aspect 7: The method of Aspect 6, wherein for each layer, of the multi-layer communication, un-precoded data is repeated X times, where X is an integer, and a corresponding FD-OCC-X is applied on the first set of virtual pilots and the second set of virtual pilots.

Aspect 8: The method of Aspect 6, wherein transmission precoding is applied after applying the first FD-OCC and the second FD-OCC.

Aspect 9: The method of any of Aspects 1-8, wherein the first set of virtual pilots and the second set of virtual pilots are repeated in a set of symbols, and a first time-domain OCC (TD-OCC) is applied to the first set of virtual pilots and a second, different TD-OCC is applied to the second set of virtual pilots.

Aspect 10: The method of Aspect 9, wherein for each layer, of the multi-layer communication, un-precoded data is repeated X-times, where X is an integer, and a corresponding TD-OCC-X is applied on the first set of virtual pilots and the second set of virtual pilots.

Aspect 11: The method of any of Aspects 1-10, further comprising: receiving information indicating a DMRS configuration, wherein the frequency-domain comb structure is based at least in part on the DMRS configuration.

Aspect 12: The method of Aspect 11, wherein a time and frequency structure of the first set of virtual pilots and the second set of virtual pilots is based at least in part on a demodulation reference signal configuration.

Aspect 13: The method of Aspect 12, further comprising: generating a port mapping table based at least in part on the time and frequency structure of the first set of virtual pilots and the second set of virtual pilots; and determining at least one of the first comb offset or the second comb offset based at least in part on at least one of a first port index associated with the first port or a second port index associated with the second port.

Aspect 14: The method of any of Aspects 1-13, further comprising: receiving DCI indicating a port index associated with the multi-layer communication.

Aspect 15: The method of any of Aspects 1-14, wherein a virtual pilot configuration corresponds to a demodulation reference signal configuration.

Aspect 16: The method of any of Aspects 1-15, wherein the multi-layer communication includes a DMRS, and wherein the first set of virtual pilots and the DMRS have one or more of: a same comb structure, a same comb offset, a same frequency-domain OCC, a same time-domain OCC, and a same number of contiguous symbols.

Aspect 17: The method of any of Aspects 1-16, further comprising: receiving a virtual pilot configuration, wherein the virtual pilot configuration indicates one or more of: a demodulation reference signal type, a port to comb mapping, a port to time-domain OCC mapping, a port to frequency-domain OCC mapping, or a number of contiguous virtual pilot symbols.

Aspect 18: The method of any of Aspects 1-17, further comprising: receiving a DMRS configuration, wherein the DMRS configuration indicates a DMRS symbol that is replaced by a virtual pilot symbol.

Aspect 19: The method of Aspect 18, wherein a bitmap is used to indicate the DMRS symbol that is replaced by the virtual pilot symbol.

Aspect 20: The method of Aspect 18, wherein the configuration indicates a starting symbol index from which the DMRS symbol, and later DMRS symbols, are replaced with virtual pilot symbols.

Aspect 21: A method of wireless communication performed by a wireless communication device, comprising: transmitting, via a first port, a first layer of a multi-layer communication, wherein data carrying first virtual pilots associated with the first layer is carried in a first set of data tones associated with a first comb offset of a frequency-domain comb structure; and transmitting, via a second port, a second layer of the multi-layer communication, wherein data carrying second virtual pilots associated with the second layer is carried in a second set of data tones associated with a second comb offset of the frequency-domain comb structure.

Aspect 22: The method of Aspect 21, wherein the frequency domain comb structure comprises a comb-2 structure, and wherein the first virtual pilots are carried in every other frequency tone of the comb-2 structure.

Aspect 23: The method of any of Aspects 21-22, further comprising: constructing the multi-layer communication per port based at least in part on the first comb offset and the second comb offset.

Aspect 24: The method of any of Aspects 21-23, wherein the first set of data tones are orthogonal to the second set of data tones.

Aspect 25: The method of any of Aspects 21-24, wherein a data tone is repeated in two continuous tones of the frequency-domain comb structure, and a frequency-domain OCC is applied to the two continuous tones.

Aspect 26: The method of any of Aspects 21-25, wherein the data carrying the first set of virtual pilots and the data carrying the second set of virtual pilots are repeated in frequency tones for each layer of the multi-layer communication, and wherein a first frequency-domain OCC (FD-OCC) is applied to the data carrying the first set of virtual pilots and a second, different FD-OCC is applied to the data carrying the second set of virtual pilots.

Aspect 27: The method of Aspect 26, wherein for each layer, of the multi-layer communication, un-precoded data is repeated X times, where X is an integer, and a corresponding FD-OCC-X is applied on the first set of virtual pilots and the second set of virtual pilots.

Aspect 28: The method of Aspect 26, wherein transmission precoding is applied after applying the first FD-OCC and the second FD-OCC.

Aspect 29: The method of any of Aspects 21-28, wherein the first set of virtual pilots and the second set of virtual pilots are repeated in a set of symbols, and a first time-domain OCC (TD-OCC) is applied to the first set of virtual pilots and a second, different TD-OCC is applied to the second set of virtual pilots.

Aspect 30: The method of Aspect 29, wherein for each layer, of the multi-layer communication, un-precoded data is repeated X-times, where X is an integer, and a corresponding TD-OCC-X is applied on the first set of virtual pilots and the second set of virtual pilots.

Aspect 31: The method of any of Aspects 21-30, further comprising: receiving information indicating a DMRS configuration, wherein the frequency-domain comb structure is based at least in part on the DMRS configuration.

Aspect 32: The method of Aspect 31, wherein a time and frequency structure of the first set of virtual pilots and the second set of virtual pilots is based at least in part on a demodulation reference signal configuration.

Aspect 33: The method of Aspect 32, further comprising: generating a port mapping table based at least in part on the time and frequency structure of the first set of virtual pilots and the second set of virtual pilots; and determining at least one of the first comb offset or the second comb offset based at least in part on at least one of a first port index associated with the first port or a second port index associated with the second port.

Aspect 34: The method of any of Aspects 21-33, further comprising: transmitting DCI indicating a port index associated with the multi-layer communication.

Aspect 35: The method of any of Aspects 21-34, wherein a virtual pilot configuration corresponds to a demodulation reference signal configuration.

Aspect 36: The method of any of Aspects 21-35, wherein the multi-layer communication includes a DMRS, and wherein the first set of virtual pilots and the DMRS have one or more of: a same comb structure, a same comb offset, a same frequency-domain OCC, a same time-domain OCC, and a same number of contiguous symbols.

Aspect 37: The method of any of Aspects 21-36, further comprising: receiving a virtual pilot configuration, wherein the virtual pilot configuration indicates one or more of: a demodulation reference signal type, a port to comb mapping, a port to time-domain OCC mapping, a port to frequency-domain OCC mapping, or a number of contiguous virtual pilot symbols.

Aspect 38: The method of any of Aspects 21-37, further comprising: transmitting a DMRS configuration, wherein the DMRS configuration indicates a DMRS symbol that is replaced by a virtual pilot symbol.

Aspect 39: The method of Aspect 38, wherein a bitmap is used to indicate the DMRS symbol that is replaced by the virtual pilot symbol.

Aspect 40: The method of Aspect 38, wherein the configuration indicates a starting symbol index from which the DMRS symbol, and later DMRS symbols, are replaced with virtual pilot symbols.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A wireless communication device for wireless communication, comprising:
one or more memories; and
one or more processors, coupled to the one or more memories, configured to cause the wireless communication device to:
receive, via a first port, a first layer of a multi-layer communication, wherein data carrying first virtual pilots associated with the first layer is carried in a first set of data tones associated with a first comb offset of a frequency-domain comb structure; and
receive, via a second port, a second layer of the multi-layer communication, wherein data carrying second virtual pilots associated with the second layer is carried in a second set of data tones associated with a second comb offset of the frequency-domain comb structure.

2. The wireless communication device of claim 1, wherein the frequency domain comb structure comprises a comb-2 structure, and wherein the first virtual pilots are carried in every other frequency tone of the comb-2 structure.

3. The wireless communication device of claim 1, wherein the one or more processors are further configured to cause the wireless communication device to:
reconstruct the multi-layer communication per port based at least in part on the first comb offset and the second comb offset.

4. The wireless communication device of claim 1, wherein the first set of data tones are orthogonal to the second set of data tones.

5. The wireless communication device of claim 1, wherein a data tone is repeated in two continuous tones of the frequency-domain comb structure, and a frequency-domain orthogonal cover code is applied to the two continuous tones.

6. The wireless communication device of claim 1, wherein the data carrying the first set of virtual pilots and the data carrying the second set of virtual pilots are repeated in frequency tones for each layer of the multi-layer communication, and wherein a first frequency-domain orthogonal cover code (FD-OCC) is applied to the data carrying the first set of virtual pilots and a second, different FD-OCC is applied to the data carrying the second set of virtual pilots.

7. The wireless communication device of claim 1, wherein the first set of virtual pilots and the second set of virtual pilots are repeated in a set of symbols, and a first time-domain orthogonal cover code (TD-OCC) is applied to the first set of virtual pilots and a second, different TD-OCC is applied to the second set of virtual pilots.

8. The wireless communication device of claim 1, wherein the one or more processors are further configured to cause the wireless communication device to:
receive information indicating a demodulation reference signal (DMRS) configuration, wherein the frequency-domain comb structure is based at least in part on the DMRS configuration.

9. The wireless communication device of claim 8, wherein a time and frequency structure of the first set of virtual pilots and the second set of virtual pilots is based at least in part on a demodulation reference signal configuration.

10. The wireless communication device of claim 9, wherein the one or more processors are further configured to cause the wireless communication device to:
generate a port mapping table based at least in part on the time and frequency structure of the first set of virtual pilots and the second set of virtual pilots; and
determine at least one of the first comb offset or the second comb offset based at least in part on at least one of a first port index associated with the first port or a second port index associated with the second port.

11. The wireless communication device of claim 1, wherein the one or more processors are further configured to cause the wireless communication device to:
receive downlink control information (DCI) indicating a port index associated with the multi-layer communication.

12. The wireless communication device of claim 1, wherein a virtual pilot configuration corresponds to a demodulation reference signal configuration.

13. The wireless communication device of claim 1, wherein the multi-layer communication includes a demodulation reference signal (DMRS), and wherein the first set of virtual pilots and the DMRS have one or more of: a same comb structure, a same comb offset, a same frequency-domain orthogonal cover code (OCC), a same time-domain OCC, and a same number of contiguous symbols.

14. The wireless communication device of claim 1, wherein the one or more processors are further configured to cause the wireless communication device to:
receive a virtual pilot configuration, wherein the virtual pilot configuration indicates one or more of: a demodulation reference signal type, a port to comb mapping, a port to time-domain orthogonal cover code (OCC) mapping, a port to frequency-domain OCC mapping, or a number of contiguous virtual pilot symbols.

15. The wireless communication device of claim 1, wherein the one or more processors are further configured to cause the wireless communication device to:
receive a demodulation reference signal (DMRS) configuration, wherein the DMRS configuration indicates a DMRS symbol that is replaced by a virtual pilot symbol.

16. The wireless communication device of claim 15, wherein a bitmap is used to indicate the DMRS symbol that is replaced by the virtual pilot symbol.

17. The wireless communication device of claim 16, wherein the configuration indicates a starting symbol index from which the DMRS symbol, and later DMRS symbols, are replaced with virtual pilot symbols.

18. A wireless communication device for wireless communication, comprising:
one or more memories; and
one or more processors, coupled to the one or more memories, configured to cause the wireless communication device to:
transmit, via a first port, a first layer of a multi-layer communication, wherein data carrying first virtual pilots associated with the first layer is carried in a first set of data tones associated with a first comb offset of a frequency-domain comb structure; and
transmit, via a second port, a second layer of the multi-layer communication, wherein data carrying second virtual pilots associated with the second layer is carried in a second set of data tones associated with a second comb offset of the frequency-domain comb structure.

19. The wireless communication device of claim 18, wherein the frequency domain comb structure comprises a comb-2 structure, and wherein the first virtual pilots are carried in every other frequency tone of the comb-2 structure.

20. The wireless communication device of claim 18, wherein the one or more processors are further configured to cause the wireless communication device to:
construct the multi-layer communication per port based at least in part on the first comb offset and the second comb offset.

21. The wireless communication device of claim 18, wherein the first set of data tones are orthogonal to the second set of data tones.

22. The wireless communication device of claim 18, wherein a data tone is repeated in two continuous tones of the frequency-domain comb structure, and a frequency-domain orthogonal cover code is applied to the two continuous tones.

23. The wireless communication device of claim 18, wherein the data carrying the first set of virtual pilots and the data carrying the second set of virtual pilots are repeated in frequency tones for each layer of the multi-layer communication, and wherein a first frequency-domain orthogonal cover code (FD-OCC) is applied to the data carrying the first set of virtual pilots and a second, different FD-OCC is applied to the data carrying the second set of virtual pilots.

24. The wireless communication device of claim 18, wherein the first set of virtual pilots and the second set of virtual pilots are repeated in a set of symbols, and a first time-domain orthogonal cover code (TD-OCC) is applied to the first set of virtual pilots and a second, different TD-OCC is applied to the second set of virtual pilots.

25. The wireless communication device of claim 18, wherein the one or more processors are further configured to cause the wireless communication device to:
transmit information indicating a demodulation reference signal (DMRS) configuration, wherein the frequency-domain comb structure is based at least in part on the DMRS configuration.

26. The wireless communication device of claim 18, wherein a time and frequency structure of the first set of virtual pilots and the second set of virtual pilots is based at least in part on a demodulation reference signal configuration.

27. The wireless communication device of claim 18, wherein the one or more processors are further configured to cause the wireless communication device to:
transmit downlink control information (DCI) indicating a port index associated with the multi-layer communication.

28. The wireless communication device of claim 18, wherein a virtual pilot configuration corresponds to a demodulation reference signal configuration.

29. A method of wireless communication performed by a wireless communication device, comprising:
receiving, via a first port, a first layer of a multi-layer communication, wherein data carrying first virtual pilots associated with the first layer is carried in a first set of data tones associated with a first comb offset of a frequency-domain comb structure; and
receiving, via a second port, a second layer of the multi-layer communication, wherein data carrying second virtual pilots associated with the second layer is carried in a second set of data tones associated with a second comb offset of the frequency-domain comb structure.

30. A method of wireless communication performed by a wireless communication device, comprising:
transmitting, via a first port, a first layer of a multi-layer communication, wherein data carrying first virtual pilots associated with the first layer is carried in a first set of data tones associated with a first comb offset of a frequency-domain comb structure; and
transmitting, via a second port, a second layer of the multi-layer communication, wherein data carrying second virtual pilots associated with the second layer is carried in a second set of data tones associated with a second comb offset of the frequency-domain comb structure.
